(19) United States
(12) Patent Application Publication
(10) Pub. No.: US 2026/0367018 A1
(43) Pub. Date: Nov. 19, 2026

(54) INSPECTION APPARATUS

(71) Applicant: ANRITSU CORPORATION, Kanagawa (JP)

(72) Inventors: Hiro KUMAZAWA, Kanagawa (JP); Shunsuke ISHIHARA, Kanagawa (JP); Tomo SAIGUSA, Kanagawa (JP)

(21) Appl. No.: 19/655,083

(22) Filed: Apr. 22, 2026

(30) Foreign Application Priority Data
May 16, 2025 (JP) 2025-082848

(51) Int. Cl. G01N 23/083; G01G 19/52; G01N 23/10

(52) U.S. Cl. CPC G01N 23/083; G01G 19/52; G01N 23/10; G01N 2223/643

(57) ABSTRACT

Provided is an inspection apparatus that accurately measures a weight without being affected by variations in measured values due to creasing or bending of a packaging material or by uneven distribution of contents in the packaging material. The inspection apparatus includes an image acquisition unit that acquires an image of an inspection object, which is transported and includes the content therein, a signal generation unit that generates an image recognition signal corresponding to a physical property of the inspection object from the acquired image, a weighing unit that measures a weight of the inspection object, and a control unit. The control unit recognizes an interval occupied by the content in a transport direction from a waveform of a portion where a value of the image recognition signal exceeds a predetermined threshold value, and instructs a measurement timing based on the recognized interval.

### TECHNICAL FIELD

The present invention relates to an inspection apparatus.

### BACKGROUND ART

An apparatus that measures a weight of an article sequentially transported by a conveyor is known. The present apparatus includes an X-ray detection unit and a weight measurement unit, and detects an article transported by a transport conveyor with X-rays and measures a weight of the article at a timing based on an X-ray detection signal (see Patent Document 1).

### RELATED ART DOCUMENT

### Patent Document

Patent Document 1 Japanese Patent No. 5623197

### DISCLOSURE OF THE INVENTION

### Problem that the Invention is to Solve

In a case where an inspection apparatus for the purpose of weight measurement is operated, a timing of a measurement start and a timing of a measurement end are determined by ascertaining a position of an article using a signal of a light projector-receiver, and are used for the weight measurement. However, a problem may occur in a case where an inspection object as an article to be inspected includes a content wrapped in a packaging material. For example, variations may occur in a signal value for detecting the position due to creasing, bending, or the like of the packaging material. In addition, in each inspection object, there is a possibility that a position of the content is biased inside the packaging material. Therefore, depending on the timing of the signal, for example, there is a possibility that weight measurement is started in a state where only the packaging material is placed on a scale, and there is a concern that the processing capacity and the accuracy of the weight measurement are affected.

An object of the present invention is to provide an inspection apparatus capable of accurately measuring a weight without being affected by variations in a measured value due to creasing or bending of a packaging material or uneven distribution of a content in the packaging material.

### Means for solving the problem

According to a first aspect of the present invention, there is provided an inspection apparatus including: an image acquisition unit that acquires an image of an inspection object, which is transported and includes a content therein; a signal generation unit that generates an image recognition signal corresponding to a physical property of the inspection object from the image; a weighing unit that measures a weight of the inspection object; and a control unit, in which the control unit recognizes an interval occupied by the content in the inspection object in a transport direction from a waveform of a portion where a value of the image recognition signal exceeds a threshold value, and instructs the weighing unit on a measurement timing based on the recognized interval.

According to the inspection apparatus of the first aspect of the present invention, the control unit recognizes the interval occupied by the content in the transport direction, and instructs the weighing unit on the measurement timing of the weight based on the interval, so that it is possible to start the measurement at a timing at which the content is transported, and thus it is possible to perform accurate weighing. That is, since the weight measurement can be started at a timing at which the content is transported, not at a timing at which only the packaging material is transported, it is possible to accurately measure the weight without being affected by variations in a measured value due to creasing or bending of the packaging material or uneven distribution of the content in the packaging material.

According to a second aspect of the present invention, in the inspection apparatus according to the first aspect, the control unit is configured to recognize a portion where the value of the image recognition signal exceeds the threshold value and is within a range not exceeding an upper limit threshold value higher than the threshold value, in the waveform, as the interval.

According to the inspection apparatus of the second aspect of the present invention, it can be recognized that the relevant portion is not the content in a case where the upper limit threshold value is exceeded.

According to a third aspect of the present invention, in the inspection apparatus according to the first aspect, the control unit is configured to recognize the interval according to whether or not a length of the portion where the value of the image recognition signal exceeds the threshold value in the waveform exceeds a predetermined value.

According to the inspection apparatus of the third aspect of the present invention, by determining the length, for example, in a case where the time length of the portion exceeding the threshold value does not exceed the predetermined value, the relevant portion is not recognized as the content, so that it is possible to prevent a part of the packaging material in a deep-drawn tray product or a product with a clip from being erroneously recognized as the content.

According to a fourth aspect of the present invention, in the inspection apparatus according to the third aspect, the predetermined value is settable by an input unit.

According to the inspection apparatus of the fourth aspect of the present invention, the appropriate value can be set according to an inspection article, a transporting speed, and the like.

According to a fifth aspect of the present invention, in the inspection apparatus according to the first aspect, the control unit is configured not to recognize a signal at a predetermined specific position in the transport direction as the interval in the waveform.

According to the inspection apparatus of the fifth aspect of the present invention, by ignoring the signal at the specific position, such as either one of the front and rear in the transport direction, for example, it is possible to prevent a clip portion of a product with a clip from being erroneously recognized as the content.

According to a sixth aspect of the present invention, in the inspection apparatus according to the first aspect, the image acquisition unit is an X-ray inspection machine that acquires an X-ray image. According to a seventh aspect of the present invention, in the inspection apparatus according to the second aspect, the image acquisition unit is an X-ray inspection machine that acquires an X-ray image. According to an eighth aspect of the present invention, in the inspection apparatus according to the third aspect, the image acquisition unit is an X-ray inspection machine that acquires an X-ray image. According to a ninth aspect of the present invention, in the inspection apparatus according to the fourth aspect, the image acquisition unit is an X-ray inspection machine that acquires an X-ray image. According to a tenth aspect of the present invention, in the inspection apparatus according to the fifth aspect, the image acquisition unit is an X-ray inspection machine that acquires an X-ray image.

According to the inspection apparatuses of the sixth to tenth aspects of the present invention, the image of the inspection object can be easily acquired by using a general X-ray inspection machine.

### ADVANTAGE OF THE INVENTION

According to the present invention, a weight can be accurately measured without being affected by variations in measured values due to creasing or bending of a packaging material or uneven distribution of contents in the packaging material.

### BRIEF DESCRIPTION OF THE DRAWINGS

FIG. 1 is a schematic diagram of an inspection apparatus according to an embodiment of the present invention.

FIGS. 2A and 2B are explanatory diagrams showing a measurement timing for measuring a weight of an inspection object, in which FIG. 2A is an explanatory diagram of the prior art and FIG. 2B is an explanatory diagram of the present embodiment.

FIG. 3 shows graphs of a conventional position detection signal, an image recognition signal of the embodiment, and a measured weight of the inspection object, which are obtained when the weight of the inspection object is measured.

FIGS. 4A and 4B are explanatory diagrams showing a method of recognizing an interval occupied by contents in a transport direction of the inspection object, in which FIG. 4A shows a first method and FIG. 4B shows a second method.

### BEST MODE FOR CARRYING OUT THE INVENTION

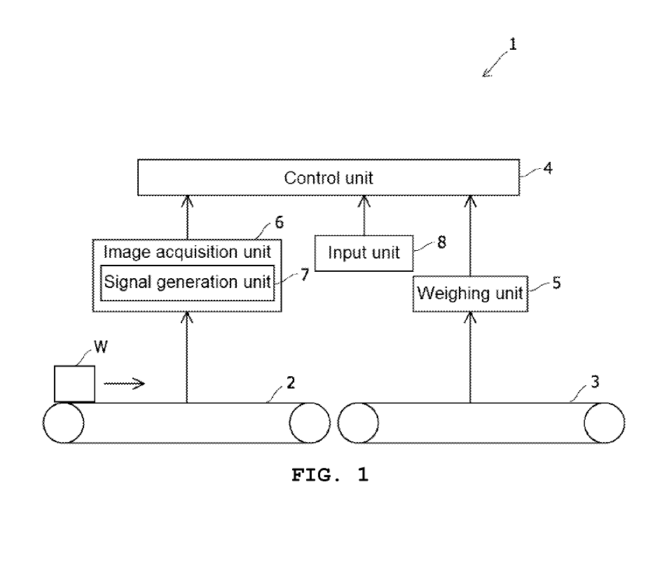

Hereinafter, an embodiment of the present invention will be described with reference to the drawings. FIG. 1 is a schematic diagram of an inspection apparatus according to an embodiment of the present invention. An inspection apparatus 1 includes an infeed conveyor 2 and a weighing conveyor 3, which are driven in the same direction by a drive motor (not shown), as transport means for transporting an inspection object W, which is an inspection target. The infeed conveyor 2 is a belt conveyor that receives the inspection object W carried in from an adjacent line or the like (not shown), transports the inspection object W, and delivers the inspection object W to the adjacent weighing conveyor 3. The weighing conveyor 3 is a belt conveyor for measuring a weight of the inspection object W while transporting the inspection object W received from the infeed conveyor 2.

The inspection apparatus 1 includes a control unit 4, an image acquisition unit 6, a signal generation unit 7, a weighing unit 5, and an input unit 8. The control unit 4 is an arithmetic processing device (computer) that is responsible for main control of the inspection apparatus 1, and is configured by a processor capable of performing various arithmetic processing. The control unit 4 reads out various programs stored in a memory (not shown) or the like, and causes each unit of the inspection apparatus 1 to execute predetermined processing.

The image acquisition unit 6 is provided at a position close to the infeed conveyor 2, such as an upper portion of the infeed conveyor 2, and acquires an image of the inspection object W. The type of the image acquisition unit 6 is not particularly limited, and may be, for example, an imaging device of an X-ray inspection machine that irradiates the inspection object W with X-rays and acquires an X-ray image of the inspection object W.

The image acquisition unit 6, which is one component of the X-ray inspection machine, digitizes the X-ray image of the inspection object W obtained from the X-ray detection signal of the X-rays transmitted through the inspection object W, and performs image processing. The X-ray image is sampled in the transport direction at a sampling pitch substantially equal to a sampling pitch on one line by the X-ray line sensor, and is imaged as the X-ray image. The X-ray image may be either an X-ray transmission image or an X-ray absorption image, but the X-ray absorption image in which the density value directly indicates the absorption amount by the substance is preferable because the X-ray absorption image is advantageous for emphasizing and detecting foreign matter having a high X-ray absorption rate.

In the X-ray absorption image, for example, in a case where an X-ray absorption rate of a substance is denoted by α and a thickness of the substance is denoted by L, an intensity S’ after X-rays having an intensity S are transmitted through the substance can be theoretically expressed as S’ = S·exp(-α·L). When the logarithm of both sides is taken and the expression is transformed, the expression can also be written as α·L = log(S) - log(S'). The X-ray transmission image corresponds to a two-dimensional distribution of S’, and can be obtained by converting into the X-ray absorption image showing the two-dimensional distribution of the absorption amount α·L by the substance by taking the logarithm and transforming as described above.

The signal generation unit 7 generates an image recognition signal corresponding to the physical property of the inspection object W from the image (for example, the X-ray image) acquired by the image acquisition unit 6. In the present example, the signal generation unit 7 generates a waveform of the image recognition signal corresponding to the thickness of the inspection object W. In the present embodiment, the signal generation unit 7 is a part of the image acquisition unit 6, but may be separate from the image acquisition unit 6.

The signal generation unit 7 obtains an absorption amount of X-rays absorbed by the inspection object W from an X-ray transmission amount of X-rays transmitted through the inspection object W based on the above-described expression for converting the X-ray transmission image into the X-ray absorption image, and generates the image recognition signal, which is a detection level signal of a density level, from the X-ray image in which a state where the inspection object W is not present is set to a 0 level. The image recognition signal is sequentially generated along transport of the inspection object W using a peak value or an average value of the density level in a width direction of the infeed conveyor 2.

The weighing unit 5 measures the weight of the inspection object W. The weighing unit 5 is, for example, a load sensor that supports the weighing conveyor 3 and outputs a weighing signal based on the load of the inspection object W, and is configured by a weighing mechanism such as an electromagnetic balance mechanism, and can measure the load applied while the inspection object W is being transported on the weighing conveyor 3. However, the weighing unit 5 may be a weighing mechanism capable of measuring the weight, and may be configured by, for example, a weighing mechanism such as a differential transformer mechanism or a strain gauge mechanism.

The input unit 8 is an interface for the user to give an instruction or information necessary for the control unit 4, and is configured by an input device such as a keyboard, a mouse, and a touch panel.

The image acquisition unit 6 and the weighing unit 5 may be a single integrated device rather than separate devices. The image acquisition unit 6 may be an appearance inspection apparatus in a case where the exterior of the inspection object W is transparent.

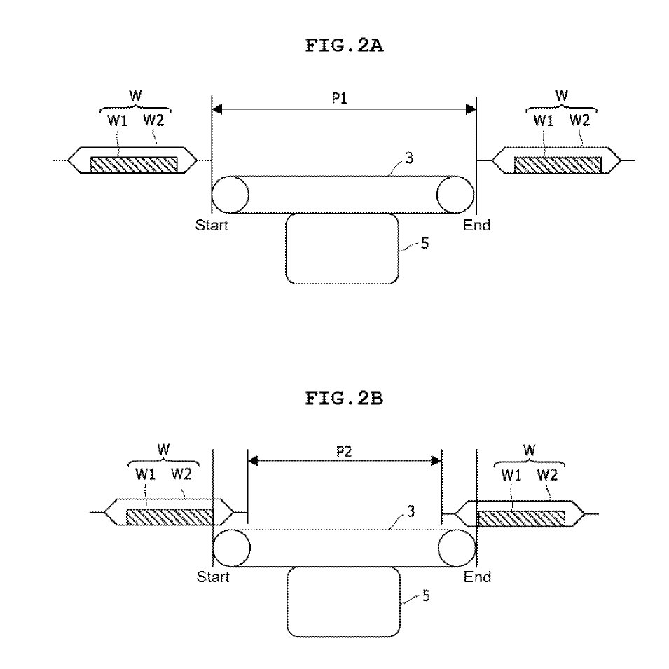

In the present embodiment, the weighing unit 5 measures the weight of the inspection object W according to the measurement timing of the weight instructed by the control unit 4. FIGS. 2A and 2B are explanatory diagrams showing a measurement timing at which the weight of the inspection object W is measured, in which FIG. 2A is an explanatory diagram of the prior art, and FIG. 2B is an explanatory diagram of the present embodiment. In the inspection object W, a content W1, which is an original inspection target, is packaged by a packaging material W2.

As shown in FIG. 2A, in the inspection apparatus of the prior art, a position detecting device such as a light projector-receiver captures an edge (front end, rear end) of the packaging material W2, which is an edge of the inspection object W, and uses the captured edge for a measurement timing of measurement start and measurement end. Therefore, a length of the measurement timing corresponds to a pitch P1 between a rear end of a preceding packaging material W2 and a front end of a following packaging material W2 between adjacent inspection objects W.

The inspection apparatus of the prior art determines the measurement timing according to the detection of the packaging material W2. However, there is a high possibility that the packaging material W2 may be creased, bent, or the like, and variations may occur in a position at which the edge (front end, rear end) of the packaging material W2 is detected in each of the inspection objects W. In addition, in each inspection object, there is a possibility that a position of the content W1 is biased inside the packaging material W2. Therefore, depending on a timing of the image recognition signal, for example, there is a possibility that the weight measurement is started or ended in a state in which only the packaging material W2 is placed on the weighing unit 5, and there is a concern that the processing capacity and the accuracy of the weight measurement are affected.

On the other hand, as shown in FIG. 2B, the control unit 4 of the present embodiment starts the measurement by using the image recognition signal generated by the signal generation unit 7. In particular, the control unit 4 recognizes an interval occupied by the content W1 in the transport direction from a waveform of a portion where a value of the image recognition signal generated by the signal generation unit 7 exceeds a threshold value, and instructs the measurement timing based on the interval. Therefore, the length of the measurement timing between the measurement start and the measurement end is equal to the length between the rear end of the preceding content W1 and the front end of the following content W1, and is larger than a pitch P2 between the rear end of the preceding packaging material W2 and the front end of the following packaging material W2 between the adjacent inspection objects W. In other words, since the pitch P2 of the embodiment is shorter than the pitch P1 of the prior art, it is possible to transport more inspection objects W in a unit time, and the processing capacity of the inspection apparatus is improved.

According to the present embodiment, the start and the end of the weight measurement can be determined based on the detection timing of the content W1. That is, the start and the end of the measurement timing can be set to be equal to the interval occupied by the content W1. Therefore, the weight of the content W1 itself can be more accurately measured, and a deviation in the measurement timing caused by creasing, bending of the packaging material W2, or the bias of the position of the content W1 inside the packaging material W2 can be prevented, so that the accuracy of the measurement can be improved.

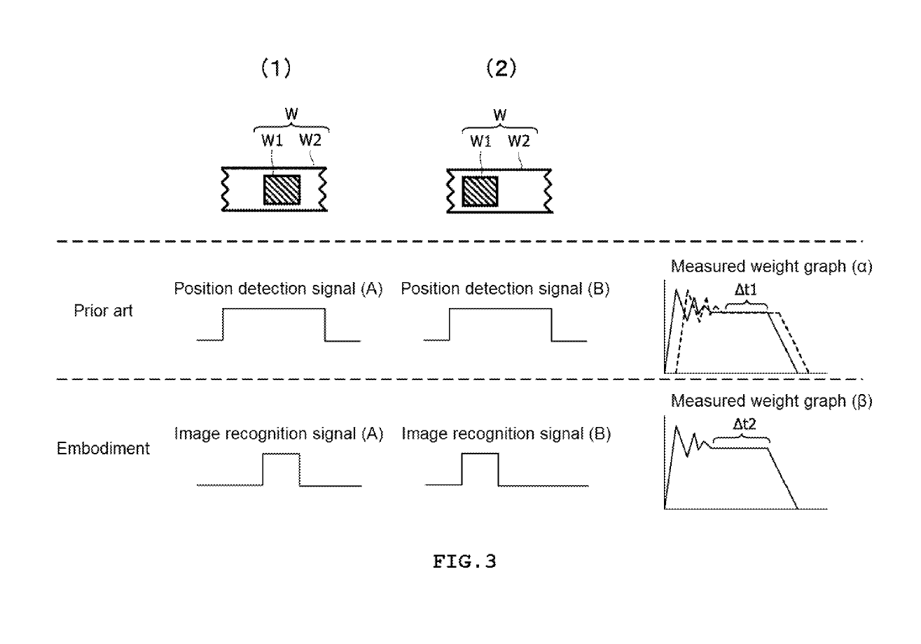

FIG. 3 shows graphs of a conventional position detection signal, an image recognition signal of the embodiment, and a measured weight of the inspection object, which are obtained during the weight measurement of the inspection object. In two inspection objects W(1) and W(2), the positions of the contents W1 are relatively shifted in the packaging material W2. In the inspection object W(1), the content W1 is disposed to be biased to the right side of the packaging material W2, and in the inspection object W(2), the content W1 is disposed to be biased to the left side of the packaging material W2. The drawings of the inspection objects W(1) and W(2) are drawings in a plan view.

In the measurement of the prior art, the measurement timing is determined according to the detection of the packaging material W2, and the position detection signal of the packaging material W2 may be a position detection signal (A) of the inspection object W(1) or a position detection signal (B) of the inspection object W(2). Therefore, a timing common to both is set as a range of the measurement timing. A measured weight graph (α) shows a result of the weight measurement by the weighing unit of the prior art. The output change of the measured weight changes according to the position of the content W1 in the packaging material W2. Therefore, in the measurement result of the inspection object W(1), the timing at which the output value of the weight increases is delayed as shown by a broken line. On the other hand, in the measurement result of the inspection object W(2), the timing at which the output value of the weight increases is earlier than the measurement result of the inspection object W(1) as shown by a solid line.

The final weight is generally a value obtained at a timing at which the measurement result of the inspection object W by the weighing unit is stable. However, as shown in the inspection object W(1) and the inspection object W(2), it is expected that the timings at which the stable values are obtained in each of the inspection objects W deviate from each other due to the positional deviation of the content W1. In this case, it is necessary to obtain the final weight by taking a common time at which the values are stable in each of the inspection objects W. Such a common time is Δt1 as shown in the drawing, and as the positional deviation of the content W1 increases, the timing at which the value is stable also deviates, and Δt1 is also shortened, which may adversely affect the measurement accuracy.

On the other hand, in the measurement of the embodiment, the weighing unit 5 measures the weight based on the measurement timing according to the instruction of the control unit 4, that is, based on the value of the image recognition signal according to the detection of the content W1. The image recognition signal of the content W1 may be the image recognition signal (A) of the inspection object W(1) or the image recognition signal (B) of the inspection object W(2), but both are signals corresponding to the presence of the content W1.

A measured weight graph (β) shows the result of the weight measurement by the weighing unit 5 of the embodiment. The output change of the measured weight changes according to the position of the content W1 in the packaging material W2. In the case of the present embodiment, the weighing unit 5 measures the weight in response to the detection of the content W1 regardless of the packaging material W2. Therefore, in a case where there is no difference in the content W1, the timing at which the output value of the weight increases does not deviate, and the measurement result of the inspection object W(1) and the measurement result of the inspection object W(2) are equal to each other as shown in the drawing.

As in the prior art, the final weight is a value obtained at a timing at which the measurement result of the inspection object W by the weighing unit 5 is stable. In the present embodiment, the timings at which stable values are obtained for each of the inspection objects W basically do not deviate from each other due to the positional deviation of the content W1. Therefore, the timing at which the value is stable for each of the inspection objects W is common, the time required to obtain the final weight is Δt2 as shown in the drawing, there is no influence from the positional deviation of the content W1, a longer time than Δt1 in the prior art can be secured, and the measurement accuracy is improved. In addition, since the time of the measurement range can be increased, the weight can be measured even when the transporting speed of the inspection object W is increased, and the measurement processing capacity is improved.

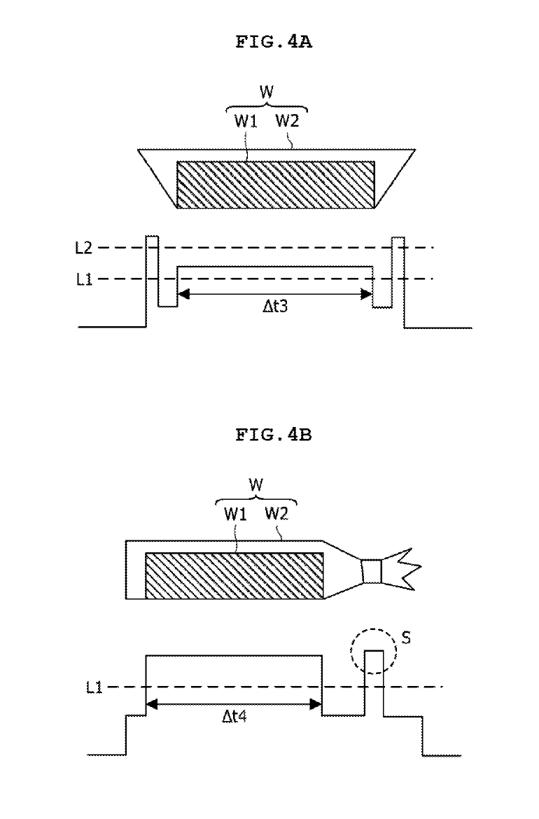

FIGS. 4A and 4B are explanatory diagrams showing a method of recognizing the interval occupied by the content W1 in the transport direction of the inspection object W, in which FIG. 4A shows a first method and FIG. 4B shows a second method. The present drawing shows the waveform of the image recognition signal generated by the signal generation unit 7 from the image acquired by the image acquisition unit 6, the image recognition signal corresponding to the physical property of the inspection object W. The height of the waveform corresponds to the thickness of the inspection object W. Basically, the control unit 4 recognizes the interval occupied by the content W1 from the waveform at a portion where the value of the image recognition signal generated by the signal generation unit 7 exceeds a predetermined threshold value. This is because it can be estimated that the larger the range in which the value of the image recognition signal is large, the higher the possibility that the content W1 is present.

However, the inspection object W includes a product including the packaging material W2 in which the value of the image recognition signal is higher than that of the content in a part of the packaging material depending on the form of the packaging material or the like, such as a product packaged in a deep-drawn tray or a product packaged with a clip. For such a product, it may be difficult to recognize the interval occupied by the content W1 only from the waveform at a portion where the predetermined threshold value is exceeded.

The first method of FIG. 4A corresponds to the inspection object W in which the value of the image recognition signal at front and rear end portions of the packaging material W2 in the transport direction is higher than that of the content. Basically, the control unit 4 recognizes the interval occupied by the content W1 from the waveform at the portion where the value of the image recognition signal generated by the signal generation unit 7 exceeds a threshold value L1. Further, the control unit 4 can recognize the portion in the waveform where the value of the image recognition signal exceeds the threshold value L1 and is within a range not exceeding an upper limit threshold value L2 higher than the threshold value L1, as an interval Δt3 occupied by the content W1. The threshold values L1 and L2 can be appropriately determined depending on the type of the product or the packaging material, and the like.

The second method of FIG. 4B corresponds to the inspection object W including the packaging material W2 having a portion in which the value of the image recognition signal is higher than the content in any one of the front or rear of the packaging material W2 in the transport direction. Basically, the control unit 4 recognizes the interval occupied by the content W1 from the waveform at the portion where the value of the image recognition signal generated by the signal generation unit 7 exceeds a threshold value L1. Further, the control unit 4 does not recognize a signal S at a predetermined specific position in the transport direction of the inspection object W in the waveform as the interval occupied by the content W1, although the signal S exceeds the threshold value L1. As a result, the control unit 4 can recognize an interval Δt4 occupied by the content W1 excluding the signal S.

As described above, in the present embodiment, the control unit 4 recognizes the interval occupied by the content W1 in the transport direction of the inspection object W, and instructs the weighing unit 5 on the measurement timing of the weight based on the interval, so that the measurement can be started at the timing at which the content W1 is transported, and thus accurate weighing can be performed. That is, since the weight measurement can be started at a timing at which the content W1 is transported, instead of a timing at which only the packaging material W2 is transported as in the prior art, the weight can be accurately measured without being affected by variations in the measured value due to creasing or bending of the packaging material W2 or the uneven distribution of the content W1 in the packaging material W2.

In addition, as shown in FIG. 4A, the control unit 4 may recognize a portion in the waveform where the value of the image recognition signal exceeds the threshold value L1 and is within a range not exceeding an upper limit threshold value L2 higher than the threshold value L1, as the interval occupied by the content W1. As a result, in a case where the upper limit threshold value L2 is exceeded, it can be recognized that the relevant portion is not the content W1.

In addition, as shown in FIG. 4B, the control unit 4 can omit recognizing the signal S at a predetermined specific position in the transport direction in the waveform as the interval occupied by the content W1. As a result, by ignoring the signal at the specific position, such as any of the front or rear in the transport direction, for example, it is possible to prevent the clip portion of the product with a clip from being erroneously recognized as the content W1.

In addition, the control unit 4 may recognize the interval occupied by the content W1 in the waveform according to whether or not the length of the portion where the value of the image recognition signal exceeds the threshold value L1 exceeds a predetermined value. According to this, by determining the length, for example, in a case where the time length of the portion exceeding the threshold value L1 does not exceed the predetermined value, the relevant portion is not recognized as the content W1, so that it is possible to prevent a part of the packaging material in the deep-drawn tray product or the product with a clip from being erroneously recognized as the content.

The user may set, by the input unit 8, a predetermined value related to the length of the portion where the value of the image recognition signal exceeds the threshold value L1. As a result, an appropriate value can be set according to the inspection article, the transporting speed, and the like.

As described above, the image acquisition unit 6 may be an imaging device of an X-ray inspection machine that acquires an X-ray image. As a result, the image of the inspection object can be easily acquired by using a general X-ray inspection machine.

While various embodiments have been described above with reference to the drawings, the present disclosure is not limited to such examples. Those skilled in the art may perceive various modification examples or correction examples within the scope of the claims, and those modification examples or correction examples are understood as falling within the technical scope of the present disclosure. In addition, the components in the above-described embodiments may be combined in any manner without departing from the spirit of the present disclosure.

### DESCRIPTION OF REFERENCE NUMERALS AND SIGNS

1 Inspection apparatus

4 Control unit

5 Weighing unit

6 Image acquisition unit

7 Signal generation unit

8 Input unit

W Inspection object

W1 Content

W2 Packaging material

What is claimed is:

1. An inspection apparatus comprising:
an image acquisition unit that acquires an image of an inspection object, which is transported and includes a content therein;
a signal generation unit that generates an image recognition signal corresponding to a physical property of the inspection object from the image;
a weighing unit that measures a weight of the inspection object; and
a control unit,
wherein the control unit recognizes an interval occupied by the content in the inspection object in a transport direction from a waveform of a portion where a value of the image recognition signal exceeds a threshold value, and instructs the weighing unit on a measurement timing based on the recognized interval.

2. The inspection apparatus according to claim 1,
wherein the control unit recognizes a portion where the value of the image recognition signal exceeds the threshold value and is within a range not exceeding an upper limit threshold value higher than the threshold value, in the waveform, as the interval.

3. The inspection apparatus according to claim 1,
wherein the control unit recognizes the interval in accordance with whether or not a length of the portion where the value of the image recognition signal exceeds the threshold value in the waveform exceeds a predetermined value.

4. The inspection apparatus according to claim 3,
wherein the predetermined value is settable by an input unit.

5. The inspection apparatus according to claim 1,
wherein the control unit does not recognize a signal at a predetermined specific position in the transport direction in the waveform, as the interval.

6. The inspection apparatus according to claim 1,
wherein the image acquisition unit is an X-ray inspection machine that acquires an X-ray image.

7. The inspection apparatus according to claim 2,
wherein the image acquisition unit is an X-ray inspection machine that acquires an X-ray image.

8. The inspection apparatus according to claim 3,
wherein the image acquisition unit is an X-ray inspection machine that acquires an X-ray image.

9. The inspection apparatus according to claim 4,
wherein the image acquisition unit is an X-ray inspection machine that acquires an X-ray image.

10. The inspection apparatus according to claim 5,
wherein the image acquisition unit is an X-ray inspection machine that acquires an X-ray image.
